(19) United States
(12) Patent Application Publication
(10) Pub. No.: US 2015/0324339 A1
(43) Pub. Date: Nov. 12, 2015

(54) PROVIDING FACTUAL SUGGESTIONS WITHIN A DOCUMENT

(71) Applicant: Google Inc., Mountain View, CA (US)

(72) Inventors: Maxim Gubin, Walnut Creek, CA (US); Krishna Bharat, Palo Alto, CA (US); Sangsoo Sung, Palo Alto, CA (US); Kenneth W. Dauber, Palo Alto, CA (US)

(73) Assignee: Google Inc., Mountain View, CA (US)

(21) Appl. No.: 14/275,478

(22) Filed: May 12, 2014

(51) Int. Cl. G06F 17/24; G06F 17/30

(52) U.S. Cl. CPC G06F 17/24; G06F 17/30477

(57) ABSTRACT

Methods, systems, and apparatus, including computer programs encoded on a computer storage medium, for providing suggestions within a document. In one aspect, a method includes obtaining textual input provided to a document editing application by a user device, the textual input being provided to the document editing application for inclusion in a document, and wherein the document includes prior text that was included in the document prior to the textual input; identifying an entity based on entity text included in the textual input; identifying an attribute of the entity based on attribute text included in the textual input; generating a query specifying the entity and the attribute; providing the query to a search system that provides a result value for the attribute of the entity included in the query; and providing the result value to the user device as a suggestion for inclusion in the document.

### BACKGROUND

This specification relates to providing suggestions within a document.

Document editing applications provide authors with many tools to assist users with drafting documents, such as word processing documents, e-mail messages, and network blog posts. The assistance provided by these tools varies greatly, from design assistance tools for designing layouts and formatting text, to revision tracking tools for tracking document changes. Other tools provide assistance based on the text included in the document, such as spell checking tools that check text for spelling errors, and grammar checking tools that check text for grammatical errors. Each tool provided by a document editing application is generally designed to enhance the user's experience in drafting a document.

### SUMMARY

This specification describes technologies relating to providing suggestions for inclusion in a document.

In general, one innovative aspect of the subject matter described in this specification can be embodied in methods that include the actions of obtaining textual input provided to a document editing application by a user device, the textual input being provided to the document editing application for inclusion in a document, and wherein the document includes prior text that was included in the document prior to the textual input; identifying an entity based on entity text included in the textual input; identifying an attribute of the entity based on attribute text included in the textual input; generating a query specifying the entity and the attribute; providing the query to a search system that provides a result value for the attribute of the entity included in the query; and providing the result value to the user device as a suggestion for inclusion in the document. Other embodiments of this aspect include corresponding systems, apparatus, and computer programs, configured to perform the actions of the methods, encoded on computer storage devices.

These and other embodiments can each optionally include one or more of the following features. The method may include: identifying a first value included in the textual input, the first value being for the attribute of the entity; determining, based on the result value, that the first value has an alternate value; and providing the user device with data that causes display of an alternate value indication.

Providing the result value may include replacing the first value with the result value.

The result value may have a confidence score that indicates a confidence that the result value is correct for the attribute of the entity, and the method may further include: determining, based on the confidence score for the result value, that the result value will be provided to the user device, and wherein the result value is provided only in response to the determination that the result value will be provided.

The search system may provide a plurality of result values for the attribute of the entity included in the query, and each of the plurality of result values may have a confidence score that indicates a confidence that the result value is correct for the attribute of the entity, and the method may further include: generating a list of two or more of the plurality of result values based on the confidence scores, wherein each of the two or more result values are placed in an ordinal position in the list according to the confidence score for the result value, and wherein providing the result value to the user device comprises providing the user device with data that causes presentation of the list.

The entity text may include a pronoun, and identifying the entity may include identifying the entity from other text associated with the document, the other text being text to which the pronoun corresponds.

The method may further include identifying a qualification included in the textual input, the qualification corresponding to a restriction on potential values for the attribute of the entity, and the query may further include the restriction.

In general, another aspect of the subject matter described in this specification can be embodied in methods that include the actions of obtaining textual input provided to a document editing application by a user device, the textual input being provided to the document editing application for inclusion in the document, and wherein the document includes prior text that was included in the document prior to the textual input; identifying a query indicator included in the textual input, the query indicator comprising one or more pre-determined characters, and in response: identifying an entity based on entity text included in the textual input; identifying an attribute of the entity based on attribute text included in the textual input; generating a query specifying the entity and the attribute; providing the query to a search system that provides a result value for the attribute of the entity included in the query; and providing the result value to the user device as a suggestion for inclusion in the document; wherein the identifying an entity, identifying an attribute, generating a query, providing the query, and providing the value are performed in response to identifying the query indicator. Other embodiments of this aspect include corresponding systems, apparatus, and computer programs, configured to perform the actions of the methods, encoded on computer storage devices.

These and other embodiments can each optionally include the following feature: providing the result value to the user device may include replacing the query indicator with the result value.

Particular embodiments of the subject matter described in this specification can be implemented so as to realize one or more of the following advantages. Providing suggestions for inclusion in a document may reduce the need for users to manually draft portions of a document. A user may forget, or be unaware of, various facts or other information that the user wishes to include in a document, and a suggestion system may be able to assist the user by providing them with information the user needs, without requiring explicit user requests for assistance. Users may also request a suggestion within a document by providing one or more characters that instruct a document editing application to request a suggestion for the user. In addition, a document editing application may check facts included in a document to verify their accuracy, notifying a user of inaccurate facts and/or providing correct facts. Providing suggestions in the foregoing manner may enhance users' document authoring experience and provide users' with information that satisfies their informational needs.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment in which suggestions are provided for a document.

FIG. 2 is an illustration of an example process for providing suggestions within a document.

FIG. 3 is a flow diagram of an example process in which suggestions are provided for a document.

FIG. 4A is an illustration of a first example environment in which textual suggestions are displayed for inclusion in a document.

FIG. 4B is an illustration of a second example environment in which textual suggestions are displayed for inclusion in a document.

FIG. 5 is a block diagram of an example data processing apparatus.

Like reference numbers and designations in the various drawings indicate like elements.

### DETAILED DESCRIPTION

A suggestion system provides suggestions for users editing documents. A document is a computer file containing text, such as a word processing document, an e-mail message, a blog post, an SMS, MMS or similar text message, or a web page, as well as text entry fields in applications and the like. Users may edit documents using a document editing application, which may include, for example, a word processor application, an e-mail client application, an illustration application, a spreadsheet application, a web-based blogging application, etc. A suggestion system may use information from various sources to assist a user in drafting and/or editing a document by providing suggestions. Suggestions may range in size from suggested characters, words, phrases, sentences, paragraphs, formulas, abbreviations, symbols, or more. As used herein, a “word” or “words” may encompass any of the foregoing, e.g., a suggested “word” may be one or more characters, words, phrases, sentences, paragraphs, formulas, abbreviations, symbols, etc. Whether suggestions are provided or not, how they are provided, and the content of the suggestions depend on various types of information related to, for example, the user editing the document, existing text included in the document, current text being inserted by the user, user data related to the user editing the document, information regarding other users and/or documents of other users, and/or other information.

In some implementations, a suggestion system can identify facts related to entities referenced in the text of a document and provide these facts as suggestions to a user device editing the document. In some implementations, entities are topics of discourse. In some implementations, entities are concepts or things that are distinguishable from one another, such as entities in a knowledge graph that relates entities by their corresponding attributes. For example, a user may type into a document, “The capital of Canada is ??” The suggestion system may identify the entity, Canada, and the attribute, capital, and formulate a query to a search system that will provide “Ottawa” as the fact the user is looking for.

The suggestion system obtains textual input, e.g., characters, words, and phrases, that was provided to a document editing application, such as a word processing application or e-mail drafting application, for inclusion in a document, such as a word processing document or e-mail. The suggestion system identifies, in the textual input, an entity and an attribute of the entity. For example, the textual input, “The atomic mass of carbon is,” includes an entity, carbon, and an attribute: atomic mass.

The suggestion system then generates a query based on the entity and entity attribute. For example, a query could be, “atomic mass of carbon.” Other types of queries may also be generated, such as a database query that queries an index of entities with corresponding attributes. The search query is provided to a search system, such as an Internet search engine or database search system, and the search system provides a result value for the attribute. In the previous example, providing the search query, “what is the atomic mass of carbon,” to an Internet search engine may result in the search engine providing the result value, “12.”

The result value provided by the search engine may be provided to the user device as a suggestion for inclusion in document. In some implementations, the textual input may include a value for the attribute, and the suggestion system can determine, e.g., based on a comparison with a result value, whether the value included in the textual input is correct or not. In situations where the textual input includes an incorrect value, the suggestion system may notify a user of the error and/or suggest the correct value instead. For example, if the textual input is, “the atomic mass of carbon is 6,” the value, 6, can be identified as incorrect based on a comparison with the correct value, 12. The correct value may be provided to the user device as a suggested replacement for the incorrect value. In some implementations, an “incorrect” value need not be wrong, but an alternate suggested value may be better, or more appropriate. If textual input includes a value for which an alternate value exists, the alternate value may be provided as a suggested replacement to the original value.

In situations in which the systems discussed here collect personal information about users, or may make use of personal information, the users may be provided with an opportunity to control whether programs or features collect user information (e.g., information about a user's social network, social actions or activities, profession, a user's preferences, or a user's current location), or to control whether and/or how to receive content from the content item management system that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content item management system.

These features and additional features are described in more detail below.

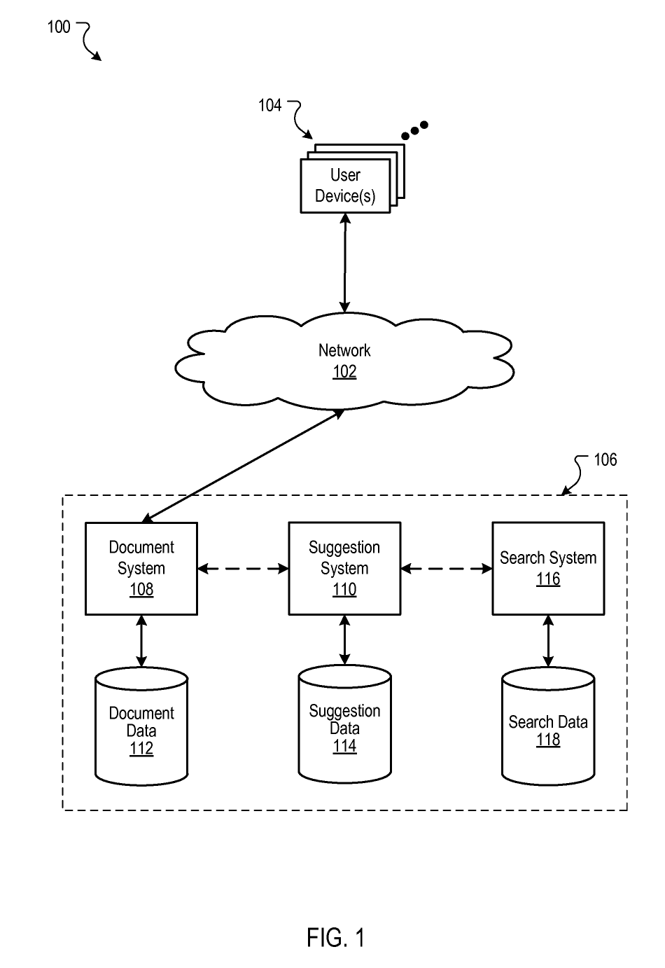

FIG. 1 is a block diagram of an example environment 100 in which suggestions are provided for a document. A computer network 102, such as a local area network (LAN), wide area network (WAN), the Internet, or a combination thereof, connects user devices 104 to a document system 108. The online environment 100 may include any number of user devices 104. In some implementations, connections between user devices 104 and the document system 108 may be local, e.g., the document system 108 may be part of or directly connected to a user device rather than connected across the network 102.

A user device 104 is an electronic device capable of requesting and receiving resources, such as documents, over the network 102. Example user devices 104 include personal computers, mobile communication devices, and other devices that can send and receive data over the network 102. A user device 104 typically includes a user application, such as a web browser, to facilitate the sending and receiving of data over the network 102. The web browser can enable a user to display and interact with text, images, videos, music, web applications, and other information typically located on a web page at a website.

A document system 108 communicates with one or more user devices 104 to provide the user devices 104 with access to documents, e.g., by providing a document editing application interface. For example, the document system 108 could be an e-mail server that provides an e-mail interface through which user devices 104 read and write e-mails, or a cloud word processing server that provides an interface through which user devices 104 create, modify, and share word processing documents, presentations, and spreadsheets.

A suggestion system 110 provides suggestions for inclusion in a document. For example, the suggestion system 110 may receive textual input from a user device, and the suggestion system 110 can use the textual input to determine whether to provide a suggestion and, if so, identify suggested text to provide to the user device. The suggestion system 110 may receive textual input from the document system 108 or, in some implementations, directly from a user device. In some implementations, the suggestion system 110 may include an entity identification component, or be connected to an entity system, capable of identifying entities, attributes, attribute values, and relationships between them in text.

The search system 116 provides search results for queries. The search system 116 may be, for example, an Internet search system, a database search system, or another type of search system or combination of search system types. The search system 116 may receive queries from the suggestion system 110, and provide search results in response. For example, an Internet search engine may receive a query, such as “atomic mass of carbon,” and the Internet search engine may search an index of Internet resources to obtain one or more results for the query.

Document data 112 is used to store data used by the document system 112 and may include, for example, document files, user data, and performance measures. The suggestion data 114 is used to store data used by the suggestion system 110 and may include, for example, an index of suggestions, suggestion model training data, performance measures for suggestions, an index of entities and entity attributes. The search data 118 is used to store data used by the search system 116 and may include, for example, a resource index. The resource index may also include an index or other searchable data structure that describes entities and their corresponding attributes. Other information may also be stored in the document data 112, suggestion data 114, and/or the search data 118. While the storage devices are depicted separately in the example environment 100, in some implementations some or all of the document data 112, suggestion data 114, and/or search data 118 may be combined or stored separately in other data storage devices.

Similarly, while the document system 108, suggestion system 110, and search system 116 are depicted separately from one another, in some implementations they may be part of the same system. For example, the suggestion system 110 could be a component of the document system 108. In some implementations, additional components or systems may be used, separately from or included in one of the depicted components. For example, an entity system may be used, separate from the suggestion system 110, to identify entities and attributes within text. In some implementations, the document system 108 or a portion thereof, such as a document editing application, may be included on a user device. For example, a document editing application running locally on a user device may communicate with a document system 108, suggestion system 110, and/or search system 116 through the network 102.

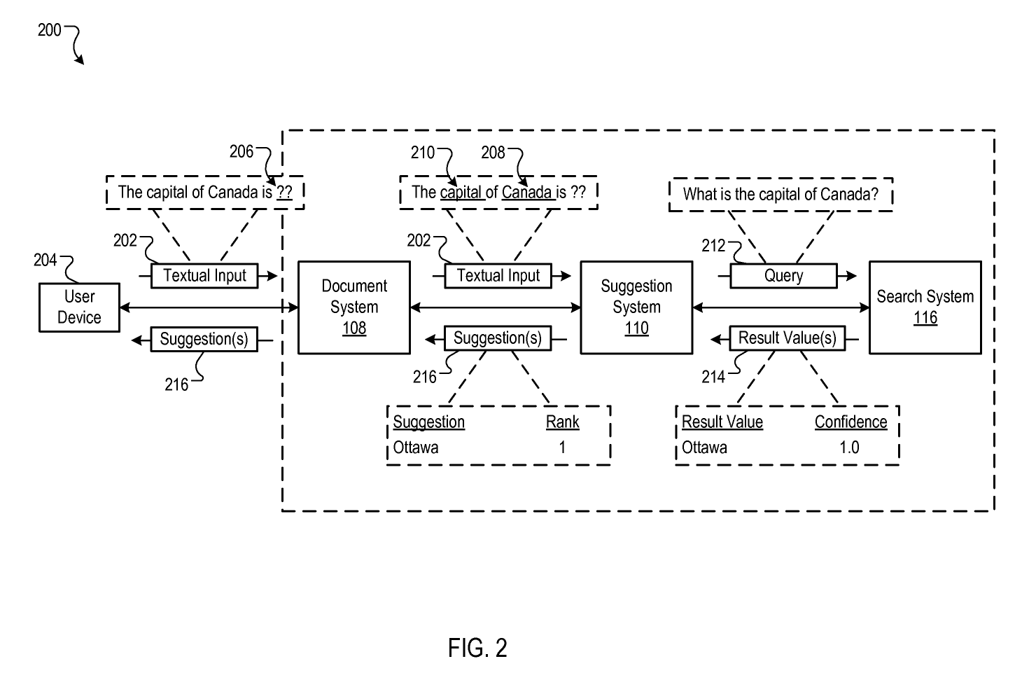

FIG. 2 is an illustration of an example process 200 for providing suggestions within a document. The document system 108 receives textual input 202 from a user device 204. For example, the document system 108 may be a word processing system that provides a document editing application that the user device 204 uses to draft a word processing document, and the textual input 202 may be text that the user device provides for inclusion in the document, e.g., textual input for the document may be, “The capital of Canada is ??.” In some implementations, the document for which the textual input 202 is provided includes prior text that was previously included in the document, e.g., entered earlier in the drafting session by the user device 204 or saved in the document during a previous editing session. Textual input may be provided by a user device 204 using any number of input methods, such as hardware or software based keyboard input and/or voice input that is transcribed to text by the user device 204 or a separate transcription service/device.

The textual input 202 is provided to the suggestion system 110 to identify one or more suggestions for inclusion in the document. In some implementations, the document system 108 or suggestion system 110 identifies a query indicator 206, e.g., “??,” in the textual input 202, and suggestions are only identified and/or provided in response to receiving a query indicator 206 in the textual input. A query indicator 206 may include one or more pre-determined characters that, when received by the document system 108, trigger the identification of a suggestion. For example, the characters, “??” in the example textual input 202 may be a special combination of characters that the document system 108 uses to determine when the textual input 202 should be provided to the suggestion system 110. Of course, many other different combinations of characters, numbers, punctuation, and so on may serve as query indicators.

In some implementations, the decision to provide the textual input 202 to the suggestion system 110 may be based on the content and/or the context of the textual input 202, and the decision may be independent of a query indicator 206. For example, a determination made based on the content of the textual input 202 may include determining whether the textual input 202 includes a misspelling or determining whether the textual input 202 includes a reference to an entity known to the suggestion system 110. Example determinations based on the context of the textual input 202 may include determining whether a user's typing speed meets a threshold typing speed, determining whether a rate acceptance of prior suggestions meets a threshold rate or acceptance, or whether a word or phrase in the textual input 202 matches another word or phrase in prior text of the document. Other methods, including one or more combinations of the above methods, may be used to determine that a suggestion should be provided to the user device 204.

The suggestion system 110 identifies an entity based on entity text 208 included in the textual input 202. For example, “The capital of Canada is ??” includes the entity text 208, “Canada.” The identification may be performed by an entity identification system that is separate from or included in the suggestion system 110. For example, the textual input 202 may be provided to an entity identification model that is trained to identify entities within text. As another example, words and/or phrases in the textual input 202 may be compared to an entity index to identify entities included in the textual input 202. Other methods for identifying one or more entities within the textual input 202 may also be used. For example, entity text may, in some implementations, include a pronoun, and the entity may be identified from other text included in the document, such as text included in the document prior to the pronoun. For example, “Its capital is,” as textual input includes entity text, “It,” and an entity system may determine the subject of the sentence preceding the textual input to determine the entity to which “It” refers.

The suggestion system 110 also identifies an attribute of the identified entity based on attribute text 210 included in the textual input 202. For example, “The capital of Canada is ??” includes the attribute text 210, “capital.” As with entity identification, the attribute identification may be performed by an entity identification system that is separate from or included in the suggestion system 110. For example, the textual input 202 may be provided to an attribute identification model that is trained to identify entity attributes within text. As another example, words and/or phrases in the textual input 202 may be compared to an entity attribute index to identify entity attributes included in the textual input 202. In some implementations, attributes for an entity identified in the textual input 202 may be compared to words and phrases in the textual input 202 to identify a match. For example, the entity, Canada, may have many attributes, such as size, population, official language(s), GDP, date established, and capital, just to name a few. When Canada is identified in the textual input 202, the entity identification system may compare a list of attributes for Canada to the textual input 202 to identify the attributes of Canada that are referenced in the textual input 202. Other methods, including combinations of methods, for identifying one or more entity attributes within the textual input 202 may also be used.

After identifying an entity, e.g., Canada, and an entity attribute, e.g., capital, in the textual input 202, the suggestion system 110 generates a query 212 specifying the entity and entity attribute. For example, the example process 200 depicts the query 212, “What is the capital of Canada?” Although a natural language query is shown, any appropriate query type can be generated, such as an unstructured query, or even a query in a structured query language. The type and content of the query 212 generated by the suggestion system 110 may depend upon the type of search system 116 to which the query will be provided. For example, a semantic search system 116 may be provided with a semantic query, while a database search system may be provided with a database query.

In some implementations, one or more qualifications that limit potential values for an attribute may be included in textual input. For example, textual input, “the speed of sound in water is,” includes the entity, sound, the entity attribute, speed, and a qualification, “in water.” In this situation, the qualification is a restriction on the value, which may be included in a search query provided to the search system 116. While the foregoing example indicates that “in water” is a restriction on the speed attribute of the entity, sound, in some implementations certain restrictions may be included in their own attributes, e.g., “speed in water” may be an attribute for the entity, sound.

The query 212 is provided to the search system 116 that will provide one or more result values in response to the query 212. As noted above, different types of search systems 116 may be provided with a query 212, e.g., Internet search engines and/or database search systems. The search system 116 identifies one or more attribute values for the attribute of the entity described in the received query 212. For example, the search system 116 may use an entity index to determine that the entity, Canada, has an attribute, capital, for which the value is “Ottawa,” e.g., the capital of Canada.

In some implementations, each result value 214 has a confidence score that indicates a measure of confidence that the result value 214 is correct. In the example process 200, the result value 214 has a confidence score of 1.0, e.g., on a scale of 0 to 1, indicating a maximum measure of confidence that the result value 214, “Ottawa,” is the capital of Canada. Other measures of confidence may also be used, such as a likelihood of correct identification, or a vector indicating a measure of confidence between 0 and infinity.

In some implementations, the search system 116 may provide multiple result values 214 for a particular query. The multiple values may be provided in the form of a drop down context menu at a location of the special characters. For example, a textual input may be, “?? was the actor who played the superhero in the movie, The Superhero.” An example query generated for that textual input may be, “who played the superhero in The Superhero?” If, for example, multiple superhero characters were in the movie, The Superhero, and/or if multiple movies named The Superhero existed, there may be multiple result values for the actors who played a superhero in a movie named The Superhero. In this situation, the confidence score of each result value may be useful to indicate the result value(s) in which the search system 116 has the most confidence.

In some implementations, the textual input may include a value for the attribute of the entity referenced in the textual input, and the search system 116 or suggestion system 110 may determine whether or not the value is correct based on the result value provided by the search system 116. For example, the textual input may be, “The capital of Canada is Toronto.” In this example, the suggestion system 110 may determine, based on a comparison of “Toronto” and “Ontario,” as well as the confidence score of the result value, “Ontario,” and use this information to determine that the textual input is incorrect and/or that an alternate value exists. In this situation, the suggestion system 110 may provide “Ontario” as a suggested replacement for “Toronto.” In some implementations, additional or alternate suggestions may be provided. For example, Toronto may also be an entity, and it may have the attribute, “capital of,” with the attribute value, “Ontario.” Because of the nature of this particular mistake in this example textual input, an additional or alternate suggestion may be provided to the user device to replace “Toronto” with “Ontario.”

In some implementations, the suggestion system 110 determines whether any result value(s) 214 will be provided as suggestions 216 based on the confidence scores of the result value(s) 214. For example, the result value with the highest confidence score may be selected for presentation as a suggestion. In some implementations, result values 214 may be ranked according to their confidence scores and the top N are selected for presentation as suggestions, where N is a positive integer. In some implementations, one or more thresholds may be used, e.g., result values 214 may only be selected for presentation as suggestions 216 if their respective confidence scores meet a pre-determined confidence score threshold.

In situations where multiple alternative suggestions may be eligible for presentation, confidence scores associated with one or both suggestions may be used to determine which suggestion to provide, if only one is to be provided. Confidence scores may, in some implementations, be based at least in part on context of the textual input. Using the previous example of the erroneous textual input, “The capital of Canada is Toronto,” prior text included in the document prior to the textual input may indicate that the document is related to Ontario, rather than Canada, which may increase the likelihood of suggesting “Ontario” to replace “Canada” rather than replacing “Toronto” with “Ottawa.”

At least one of the result value(s) 214 identified by the search system 116 are provided to the user device 204 as suggestions 216. For example, the suggestion system 110 may select the result value(s) 214 with the highest confidence score(s) to provide to the user device 204. In implementations where multiple result values are to be provided, the suggestion system 110 may rank the result values, e.g., according to their confidence scores, and provide the result values to the user device for display, e.g., in a list ordered according to the confidence scores. In some implementations, providing the result value 214 to the user device 204 as a suggestion 216 includes replacing the query indicator 206 with the result value. For example, the document system 108 may replace the characters, “??” with the result value 214, “Ottawa,” in the user's document. Suggestions may be provided for a variety of different application types, such as spreadsheet applications, illustration applications, and micro-blogging applications, to name a few; and other user interface options for providing suggestions and/or notifications, such as pick lists, nested lists, footnotes, etc., may also be used.

While various components, such as the document system 108, suggestion system 110, and search system 116 are depicted separately in the illustration of the example process 200, the components may be included in a single system, as shown by the dotted line encompassing the components, or a different combination of systems than the depicted combination, e.g., in a system including a separate entity identification component.

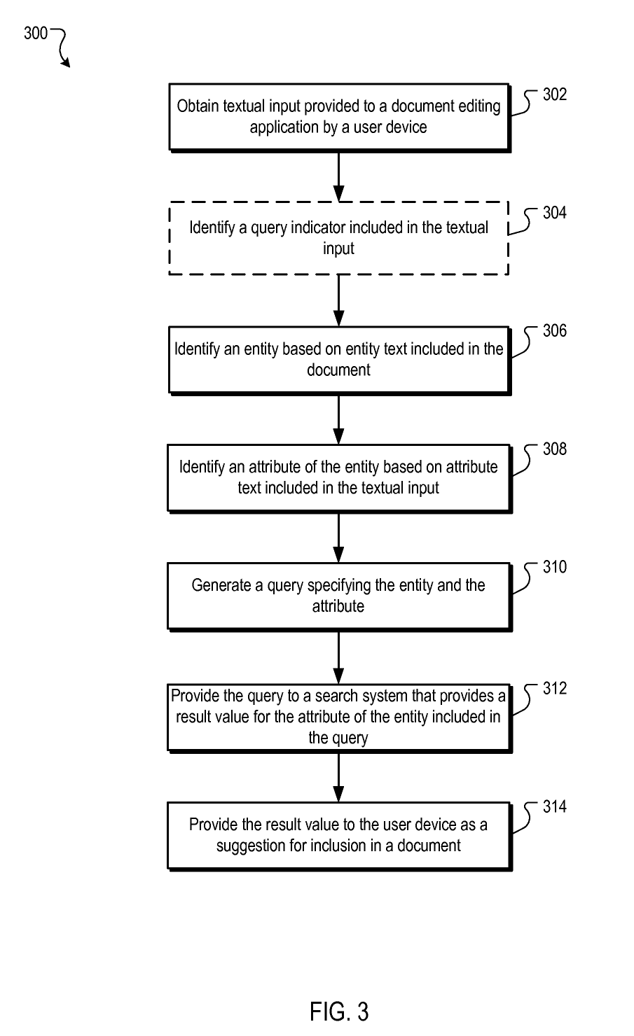

FIG. 3 is a flow diagram of an example process 300 in which suggestions are provided for a document. The process 300 may be performed by a suggestion system, such as the system described above with reference to FIG. 2.

Textual input that was provided to a document editing application by a user device is obtained (302). The textual input was provided to the document editing application for inclusion in the document, and the document includes prior text that was included in the document prior to the textual input. For example, an e-mail application may include an application interface that allows users to draft and communicate with other users via e-mail. Textual input for an e-mail may include, “My flight is scheduled to arrive at ??, so please don't be late to pick me up.”

In some implementations, a query indicator included in the textual input is identified (304). For example, the characters, “??,” may have been pre-defined as a query indicator. Whether or not a suggestion is provided for textual input may, in some implementations, depend upon whether or not the query indicator has been identified in the textual input. Alternatively, the system can be configured to provide suggestions even in the absence of the query indicator.

An entity is identified based on entity text included in the textual input (306). For example, the textual input may be provided to an entity identification model that provides, as output, one or more entities for the textual input. The entity text is text that refers to an entity. In the example textual input, “My flight is scheduled to arrive at ??, so please don't be late to pick me up,” the text, “flight,” may be entity text that refers to an airline flight, and the text, “me,” may also be entity text referring to the author of the e-mail. The specific flight referred to by the entity text may be identified in other text of the document, or other text associated with the author, e.g., text in the document if the author previously referred to a particular flight, or text included in a previously received e-mail indicating the particular flight. In some implementations, the entity text comprises a pronoun, and identifying the entity includes identifying the entity from other text associated with the document, the other text being text to which the pronoun corresponds. In the foregoing example, the entity text, “me” is a pronoun that refers to the author of the document. In some situations, the pronoun may be identified from and refer, for example, to the subject of the preceding sentence or paragraph.

An attribute of the entity is identified based on attribute text included in the textual input (308). For example, an entity identification model may also be used to identify attributes of entities in textual input. In some implementations, a separate model may be used to identify attributes within textual input. By way of example, an entity identified in textual input may have attribute terms, e.g., keywords, in an index, indicating which words may be an attribute for the entity. For example, the entity, “flight” may be associated with keywords that indicate attributes, such as “departs,” “departing,” “departure,” etc. to refer to the attribute for the flight's departure time.

In some implementations, a first value included in the textual input is identified, the first value being for the attribute of the entity. For example, if the textual input read, “My flight is scheduled to arrive at 9:00 a.m., so please don't be late to pick me up,” the text, “9:00 a.m.,” may be identified as a first value for the attribute, arrival time. In this situation, the first value may be checked for accuracy.

A query specifying the entity and the attribute is generated (310). Using the previous example, the entity text, “flight,” may refer to flight 406 from a particular airline, and the attribute text, “arrive,” may refer to the arrival time of flight 406, and the query generated may be, “when is flight 406 scheduled to arrive?” Other information, such as the airline and/or date of the flight may also be included in the query. In some implementations, a qualification included in the textual input is identified, the qualification corresponding to a restriction on potential values for the attribute of the entity, and the query includes the restriction. For example, two flights may be associated with the author of the e-mail in the prior example, and the textual input may include a qualifier, such as “first” flight or “second” flight, which may be used to identify which flight the query should be generated for. As an additional example, textual input of, “the cost of a standard USPS stamp was ?? in 1950,” includes a qualification, “in 1950,” that may be included in the query.

The query is provided to a search system that provides a result value for the attribute of the entity included in the query (312). For example, the query may be provided to an Internet search engine, an entity search system, or another search system or combination of search systems to identify one or more result values for the query. For example, a search system may provide, for the query, “when is flight 406 scheduled to arrive?,” an arrival time for flight 406, e.g., 10:00 a.m.

In implementations where a first value is identified, a determination may be made, based on the result value, that the first value is incorrect. For example, the textual input, “My flight is scheduled to arrive at 9:00 a.m., so please don't be late to pick me up,” includes a first value, “9:00 a.m.” The result value provided by the search system may be “10:00 a.m.” In this situation, the first value may be identified as an incorrect value because it does not match the result value provided by the search system. In some implementations, a determination may be made that the first value has an alternate value, e.g., a value may not be incorrect, but a better value may exist. In the foregoing situations, the user device may, in some implementations, be provided with data that causes display of an incorrect or alternate value indication, e.g., a pop-up or highlighting of the incorrect value.

In some implementations, the result value has a confidence score that indicates a confidence that the result value is correct for the attribute of the entity. In these implementations, a determination may be made, based on the confidence score for the result value, that the result value will be provided to the user device, and the result value may only be provided in response to the determination that the result value will be provided. For example, a pre-determined confidence score threshold may be used to throttle the provision of result values as suggestions to user devices, e.g., a result value must have a confidence score above 0.75 to be provided to the user device as a suggestion.

In some implementations, the search system provides multiple result values for the attribute of the entity included in the query, and each of the result values has a confidence score that indicates a confidence that the result value is correct for the attribute of the entity. In these implementations, a list of two or more of the result values may be generated based on the confidence scores, where each of the result values are placed in an ordinal position in the list according to the confidence score for the result value. For example, if a result value is a measure of distance, e.g., the distance from New York City to London, multiple measurements of distance may result in values, including a measure that uses kilometers as a measure of distance, while another result value may represent the same distance in miles. Both result values may be correct with a relatively high measure of confidence, and both may be presented to the user device in a list, e.g., so that the user may choose from the measurement represented in miles or the measurement represented in kilometers.

The result value is provided to the user device as a suggestion for inclusion in the document (314). Multiple methods may be used to provide suggestions to user devices. In some implementations, the result value is provided as an in situ suggestion, which may include inserting the result value in the appropriate position within the textual input, either with or without a notification. In implementations where an incorrect or alternate value is identified, the incorrect value, or the value for which an alternate value is identified, may be replaced by the result value. In implementations where multiple suggestions are to be provided, the user device may be provided with data that causes a list of selectable result values to be displayed, allowing the user to choose which result value to be included in the document. In implementations where a query indicator is used, the result value provided to the user device may replace the query indicator.

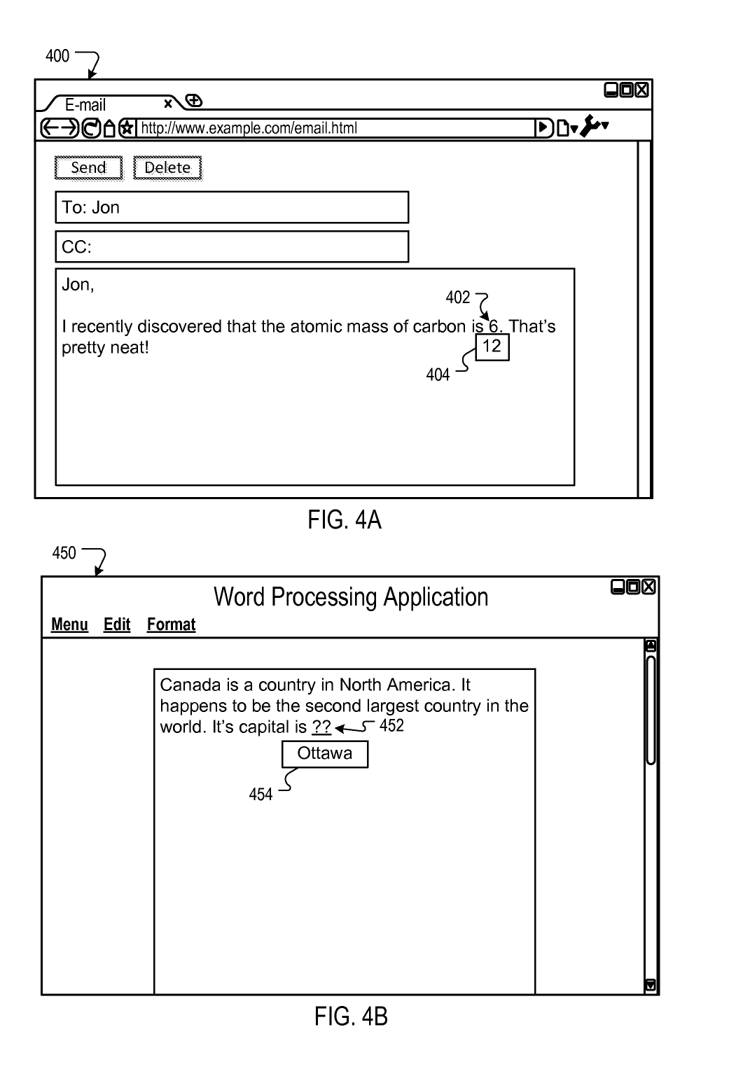

FIGS. 4A and 4B are illustrations of example environments in which textual suggestions are displayed for inclusion in a document. FIG. 4A depicts an example web-based e-mail application 400 for electronic communications. In the body of the e-mail, an incorrect value 402 has been identified for the text, “the atomic mass of carbon is 6.” The example suggestion 404, “12,” may be a suggestion that is provided as a correction for the value, “6.” For example, a suggestion system may send a query to a search system to identify the atomic mass of carbon and, after identifying an incorrect value in the input text, provide a document system with the suggestion to be provided to the user device.

FIG. 4B depicts an example word processing application 450 for creating a word processing document. The text includes a query indicator 452 indicating that the document system should seek a suggestion from a suggestion system. Any or all of the words prior to the query indicator 452 may be provided to a suggestion system, which provides the textual suggestion 454 shown in a pop-up. As noted above, the illustrations depicting textual suggestions in FIGS. 4A and 4B are examples, and other methods may also be used to display textual suggestions, including displaying indicators of suggestion confidence, providing notifications regarding an automatically inserted textual suggestion, prompting a user for authorization to obtain a suggestion, and/or providing an indicator identifying the source of a textual suggestion.

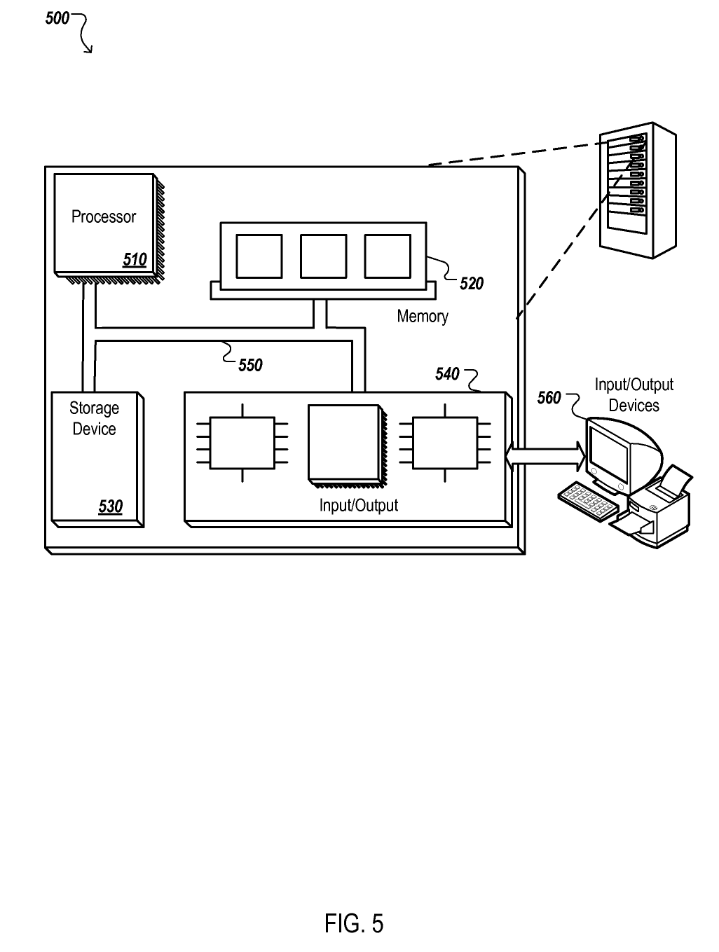

FIG. 5 is a block diagram of an example data processing apparatus 500. The system 500 includes a processor 510, a memory 520, a storage device 530, and an input/output device 540. Each of the components 510, 520, 530, and 540 can, for example, be interconnected using a system bus 550. The processor 510 is capable of processing instructions for execution within the system 500. In one implementation, the processor 510 is a single-threaded processor. In another implementation, the processor 510 is a multi-threaded processor. The processor 510 is capable of processing instructions stored in the memory 520 or on the storage device 530.

The memory 520 stores information within the system 500. In one implementation, the memory 520 is a computer-readable medium. In one implementation, the memory 520 is a volatile memory unit. In another implementation, the memory 520 is a non-volatile memory unit.

The storage device 530 is capable of providing mass storage for the system 500. In one implementation, the storage device 530 is a computer-readable medium. In various different implementations, the storage device 530 can, for example, include a hard disk device, an optical disk device, or some other large capacity storage device.

The input/output device 540 provides input/output operations for the system 500. In one implementation, the input/output device 540 can include one or more network interface devices, e.g., an Ethernet card, a serial communication device, e.g., an RS-232 port, and/or a wireless interface device, e.g., an 802.11 card. In another implementation, the input/output device can include driver devices configured to receive input data and send output data to other input/output devices, e.g., keyboard, printer and display devices 560. Other implementations, however, can also be used, such as mobile computing devices, mobile communication devices, set-top box television client devices, etc.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus.

A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., a FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's user device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a user computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include users and servers. A user and server are generally remote from each other and typically interact through a communication network. The relationship of user and server arises by virtue of computer programs running on the respective computers and having a user-server relationship to each other. In some embodiments, a server transmits data (e.g., an HTML page) to a user device (e.g., for purposes of displaying data to and receiving user input from a user interacting with the user device). Data generated at the user device (e.g., a result of the user interaction) can be received from the user device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method implemented by data processing apparatus, the method comprising:
obtaining textual input provided to a document editing application by a user device, the textual input being provided to the document editing application for inclusion in a document, and wherein the document includes prior text that was included in the document prior to the textual input;
identifying an entity based on entity text included in the textual input;
identifying an attribute of the entity based on attribute text included in the textual input;
generating a query specifying the entity and the attribute;
providing the query to a search system that provides a result value for the attribute of the entity included in the query; and
providing the result value to the user device as a suggestion for inclusion in the document.

2. The method of claim 1, further comprising:
identifying a first value included in the textual input, the first value being for the attribute of the entity;
determining, based on the result value, that the first value has an alternate value; and
providing the user device with data that causes display of an alternate value indication.

3. The method of claim 2, wherein providing the result value comprises replacing the first value with the result value.

4. The method of claim 1, wherein the result value has a confidence score that indicates a confidence that the result value is correct for the attribute of the entity, and wherein the method further comprises:
determining, based on the confidence score for the result value, that the result value will be provided to the user device, and wherein the result value is provided only in response to the determination that the result value will be provided.

5. The method of claim 1, wherein the search system provides a plurality of result values for the attribute of the entity included in the query, and each of the plurality of result values has a confidence score that indicates a confidence that the result value is correct for the attribute of the entity, and wherein the method further comprises:
generating a list of two or more of the plurality of result values based on the confidence scores, wherein each of the two or more result values are placed in an ordinal position in the list according to the confidence score for the result value, and wherein providing the result value to the user device comprises providing the user device with data that causes presentation of the list.

6. The method of claim 1, wherein the entity text comprises a pronoun, and wherein identifying the entity comprises identifying the entity from other text associated with the document, the other text being text to which the pronoun corresponds.

7. The method of claim 1, further comprising:
identifying a qualification included in the textual input, the qualification corresponding to a restriction on potential values for the attribute of the entity, and wherein the query further includes the restriction.

8. A method implemented by data processing apparatus, the method comprising:
obtaining textual input provided to a document editing application by a user device, the textual input being provided to the document editing application for inclusion in the document, and wherein the document includes prior text that was included in the document prior to the textual input;
identifying a query indicator included in the textual input, the query indicator comprising one or more pre-determined characters, and in response:
identifying an entity based on entity text included in the textual input;
identifying an attribute of the entity based on attribute text included in the textual input;
generating a query specifying the entity and the attribute;
providing the query to a search system that provides a result value for the attribute of the entity included in the query; and
providing the result value to the user device as a suggestion for inclusion in the document;
wherein the identifying an entity, identifying an attribute, generating a query, providing the query, and providing the value are performed in response to identifying the query indicator.

9. The method of claim 8, wherein providing the result value to the user device comprises replacing the query indicator with the result value.

10. A system comprising:
one or more data processing apparatus; and
a data storage device storing instructions that, when executed by the one or more data processing apparatus, cause the one or more data processing apparatus to perform operations comprising:
obtaining textual input provided to a document editing application by a user device, the textual input being provided to the document editing application for inclusion in a document, and wherein the document includes prior text that was included in the document prior to the textual input;
identifying an entity based on entity text included in the textual input;
identifying an attribute of the entity based on attribute text included in the textual input;
generating a query specifying the entity and the attribute;
providing the query to a search system that provides a result value for the attribute of the entity included in the query; and
providing the result value to the user device as a suggestion for inclusion in the document.

11. The system of claim 10, wherein the operations further comprise:
identifying a first value included in the textual input, the first value being for the attribute of the entity;
determining, based on the result value, that the first value has an alternate value; and
providing the user device with data that causes display of an alternate value indication.

12. The system of claim 11, wherein providing the result value comprises replacing the first value with the result value.

13. The system of claim 10, wherein the result value has a confidence score that indicates a confidence that the result value is correct for the attribute of the entity, and wherein the operations further comprise:
determining, based on the confidence score for the result value, that the result value will be provided to the user device, and wherein the result value is provided only in response to the determination that the result value will be provided.

14. The system of claim 10, wherein the search system provides a plurality of result values for the attribute of the entity included in the query, and each of the plurality of result values has a confidence score that indicates a confidence that the result value is correct for the attribute of the entity, and wherein the operations further comprise:
generating a list of two or more of the plurality of result values based on the confidence scores, wherein each of the two or more result values are placed in an ordinal position in the list according to the confidence score for the result value, and wherein providing the result value to the user device comprises providing the user device with data that causes presentation of the list.

15. The system of claim 10, wherein the entity text comprises a pronoun, and wherein identifying the entity comprises identifying the entity from other text associated with the document, the other text being text to which the pronoun corresponds.

16. The system of claim 10, wherein the operations further comprise:
identifying a qualification included in the textual input, the qualification corresponding to a restriction on potential values for the attribute of the entity, and wherein the query further includes the restriction.

17. A computer readable medium comprising instructions that, when executed by one or more data processing apparatus, cause the one or more data processing apparatus to perform operations comprising:
obtaining textual input provided to a document editing application by a user device, the textual input being provided to the document editing application for inclusion in a document, and wherein the document includes prior text that was included in the document prior to the textual input;
identifying an entity based on entity text included in the textual input;
identifying an attribute of the entity based on attribute text included in the textual input;
generating a query specifying the entity and the attribute;
providing the query to a search system that provides a result value for the attribute of the entity included in the query; and
providing the result value to the user device as a suggestion for inclusion in the document.

18. The computer readable medium of claim 17, wherein the operations further comprise:
identifying a first value included in the textual input, the first value being for the attribute of the entity;
determining, based on the result value, that the first value has an alternate value; and
providing the user device with data that causes display of an alternate value indication.

19. The computer readable medium of claim 18, wherein providing the result value comprises replacing the first value with the result value.

20. The computer readable medium of claim 17, wherein the result value has a confidence score that indicates a confidence that the result value is correct for the attribute of the entity, and wherein the operations further comprise:
determining, based on the confidence score for the result value, that the result value will be provided to the user device, and wherein the result value is provided only in response to the determination that the result value will be provided.
